(19) United States
(12) Patent Application Publication
(10) Pub. No.: US 2008/0253419 A1
(43) Pub. Date: Oct. 16, 2008

(54) Diode Pumped Laser

(75) Inventor: Dmitri Feklistov, South Australia (AU)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: Ellex Medical Pty, Ltd.

(21) Appl. No.: 11/995,425

(22) PCT Filed: Jul. 10, 2002
(86) PCT No.: PCT/AU06/00976

§ 371 Date: Jan. 11, 2008

(30) Foreign Application Priority Data
Jul. 11, 2005 (AU) 2005903654

(51) Int. Cl. H01S 3/091; H01S 3/082; H01S 3/00

(52) U.S. Cl. 372/38.03; 372/75; 372/97

(57) ABSTRACT

A switching mechanism (6) and a diode pumped laser system (1) incorporating the switching mechanism (6) that allows a single diode laser pump source (2) to be selectively directed to one of two or more resonant laser cavities (11a,11n). The switching mechanism (6) comprises an optical element that is movable between a first position that directs the output of the diode laser (2) along a Diode first path (8a) and a second position that directs the output of the lase diode along a second path (8n).

This invention relates to a laser apparatus. In particular, it relates to a laser diode pumped, solid state laser apparatus.

### BACKGROUND TO THE INVENTION

Laser devices are finding application in many different environments. Laser diodes are commonly used in communication and entertainment. Solid state lasers (Nd:YAG, Er: YAG, Nd:YLF, etc) and gas lasers (Excimer, Argon ion, etc) are used in a range of industrial applications for cutting and materials processing. One of the fastest growing fields for laser applications is medical treatment including surgery, and opthalmology.

The laser wavelength is an important consideration for each application. Traditionally different wavelengths have been obtained by designing lasers that generate the specific desired wavelength but within a broad application area, such as retinal laser therapy, it is often useful to be able to select a wavelength which will optimize the treatment effect. For example, a green laser wavelength is often preferred to coagulate leaking blood vessels in the retina because it is strongly absorbed by blood, while a red wavelength is preferred if it is necessary for the laser to pass through blood to treat sub-retinal layers. However, the ability to have access to a variety of single wavelength laser systems is restricted by both cost and space constraints.

To address the cost and space constrains it is useful to have one laser system that can deliver a plurality of wavelengths and share common components, rather than having a number of separate laser systems which produce one wavelength each.

One system that provides multiple output wavelengths in a single device is described in International Application number WO 2004/036705 in the name of Lumenis Inc. The Lumenis system utilises three separate laser devices which can be separately activated, to provide any one of three output wavelengths, which are then directed to a common output path. This arrangement allows the use of a common power supply, user interface, safety systems, and control systems, however the need for three of each laser component adds considerably to system size and cost.

Many lasers use a pump source to convert electrical energy into light that can then be used to excite a resonate cavity into stimulated emission of laser light of the desired wavelength. Because the pump source has a significant impact on both size and cost of most laser systems it is desirable to use a single pump source while allowing the selection of a plurality of output wavelengths, if possible, rather than use a separate pump source in the generation of each output wavelength, as in the aforementioned Lumenis system.

The use of a single pump source to produce a plurality of output wavelengths has been achieved in a number of ways in the past. Gas tube lasers such as the argon ion laser use a single pump source to produce a number of output wavelengths from which the desired wavelength can be selected. These types of lasers have many inefficiencies including the wasting of all laser energy produced other than the one desired wavelength, which results in laser systems which are relatively large and costly.

Many methods of pumping resonant laser cavities can be used, including the use of solid state diode lasers which allow a very compact and efficient pump source design to be achieved. However it is still desirable to use a single diode laser pump source to obtain multiple wavelength outputs to reduce the system size and cost. One possible solution to this problem is described in U.S. Pat. No. 6,636,537 assigned to Nidek, in which a single solid state diode laser pump source is used to excite a single laser rod within a configurable resonant cavity. In this approach the beam path direction and length within the resonator can be changed, along with the frequency conversion non-linear crystal, by electromechanical means, to allow different laser wavelengths outputs to be produced.

A major disadvantage of this approach is that the output wavelengths that can be achieved are limited by the wavelengths that can be obtained from a single laser rod and their subsequent frequency conversion by non linear crystals. Although laser rod materials such as Nd:YAG can produce a number of wavelengths, most are produced with very low efficiency compared to the primary wavelength of 1064 nm, which results in the need for a high power pump source which in turn results in increased system size and cost.

### OBJECT OF THE INVENTION

It is an object of the present invention to provide a diode laser pumped laser system which uses a switching mechanism to allow a single diode laser pump source to pump multiple laser cavities.

It is a further object of the invention to provide a switching mechanism that allows a single diode laser to pump multiple laser cavities.

Further objects will be evident from the following description.

### DISCLOSURE OF THE INVENTION

In one form, although it need not be the only or indeed the broadest form, the invention resides in a diode laser pumped laser system comprising:

a diode laser pump source;
two or more resonant laser cavities; and
a switching mechanism having:
at least one input port receiving optical radiation from the diode laser pump source;
two or more output ports each output port directing the optical radiation to one of the two or more resonant laser cavities; and
at least one switching element directing the optical radiation from the at least one input port to a selected one of the two or more output ports.

Suitably the switching element comprises one or more optical elements movable between a first position and at least a second position to direct the optical radiation along a selected optical path from the at least one input port to one of the two or more output ports.

Preferably the switching element is controlled by an actuator associated with the switching element, the actuator moving the switching element between the first position and at least the second position in response to electrical control signals.

Preferably the switching element is a rhomboid prism and the actuator is a linear translation stage. Alternately the switching element may be one or more mirrors or beam shifting/diverting prisms.

Suitably the optical radiation is delivered to the input port via an optical fibre.

This invention allows a single pump laser source to be switched to multiple resonant laser cavities by applying an appropriate electrical signal to the switching element. Each of the resonant laser cavities can be optimised to produce the desired wavelength at maximum efficiency and each is designed to accept the single diode laser pump wavelength.

By using a single pump source and resonant cavities working at maximum efficiency the overall laser system size and cost are minimised compared to prior art techniques.

In another form, the invention resides in a switching mechanism for a diode laser pumped laser system comprising:

a housing having two or more optical paths therethrough;
at least one input port receiving optical radiation directed along a common part of the two or more optical paths;
two or more output ports, there being an output port for each optical path; at least one switching element in the housing, the switching element being movable between a first position and at least a second position to direct the optical radiation along a selected one of the two or more optical paths from the at least one input port to one of the two or more output ports; and an actuator associated with the switching element, the actuator moving the switching element between the first position and at least the second position.

### BRIEF DETAILS OF THE DRAWINGS

To assist in understanding the invention preferred embodiments will now be described with reference to the following figures in which:

FIG. 1 is a block schematic of a diode laser pumped solid state laser system with a single diode laser pump and two or more selectable laser outputs;

FIG. 2 is a block schematic of a diode laser pumped solid state laser system with a single diode laser pump and three selectable laser outputs, showing resonant cavity optical elements;

FIG. 3 shows details of one embodiment of the switching mechanism;

FIG. 4 is a block schematic of the arrangement of FIG. 3 with the switching mechanism in a second position; and

FIG. 5 shows details of another embodiment of the switching mechanism.

### DETAILED DESCRIPTION OF THE DRAWINGS

In describing different embodiments of the present invention common reference numerals are used to describe like features.

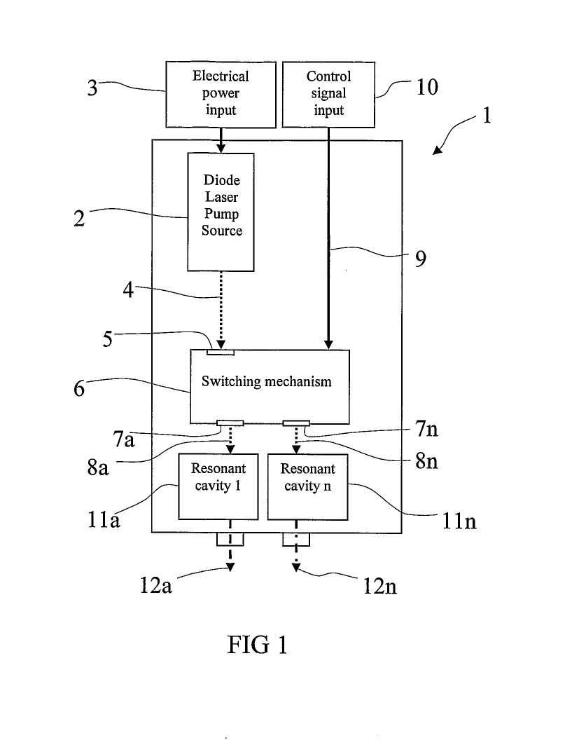

Referring to FIG. 1 there is shown a laser diode pumped solid state laser apparatus generally indicated as 1. A single laser diode pump source 2 is powered by electrical power input 3 to produce a laser beam 4. The laser beam 4 is directed to an input port 5 of a switching mechanism 6 which has multiple output ports 7a-7n. The switching mechanism 6 is actuated by control signals 9 from control signal input 10 to select between multiple optical paths between input port 5 and output ports 7a-7n. Each output beam 8a-8n from the switching mechanism 6 is associated with a resonant laser cavity 11a-11n which generates a laser beam 12a-12n of specific wavelength.

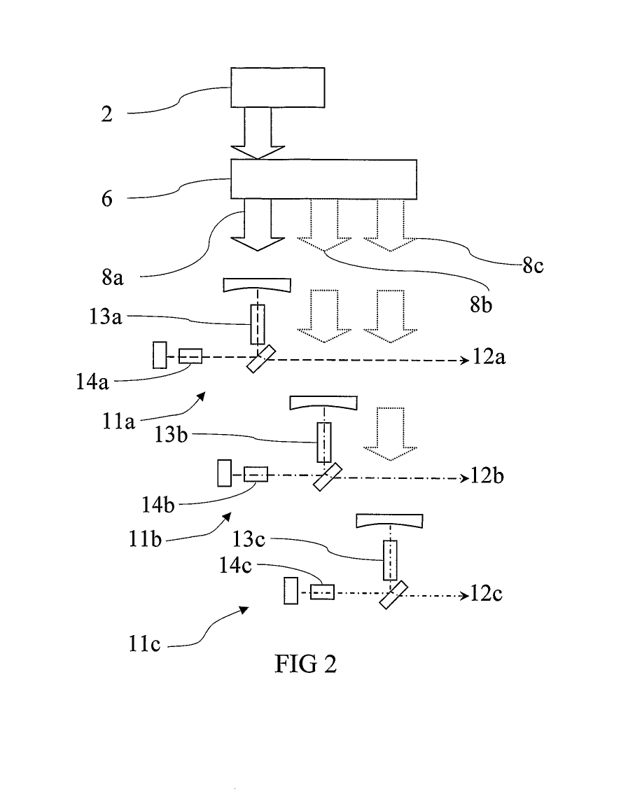

The device depicted in FIG. 1 generates multiple selectable wavelength laser beams from a single laser diode pump source, thus providing significant economic benefit compared to known systems utilising multiple laser diode pump sources. An example of a configuration producing three different laser outputs is shown in FIG. 2 to show the benefits of the invention. The switching mechanism 6 is controlled to select between the three outputs 8a, 8b, 8c which are directed to three different resonant laser cavities 11a, 11b, 11c. Each resonant cavity 11 has a solid state laser medium 13a, 13b, 13c, which has a strong absorption at the wavelength of the laser diode pump, and a non-linear crystal 14a, 14b, 14c to allow the generation of any one of three different wavelength laser beams 12a, 12b, 12c.

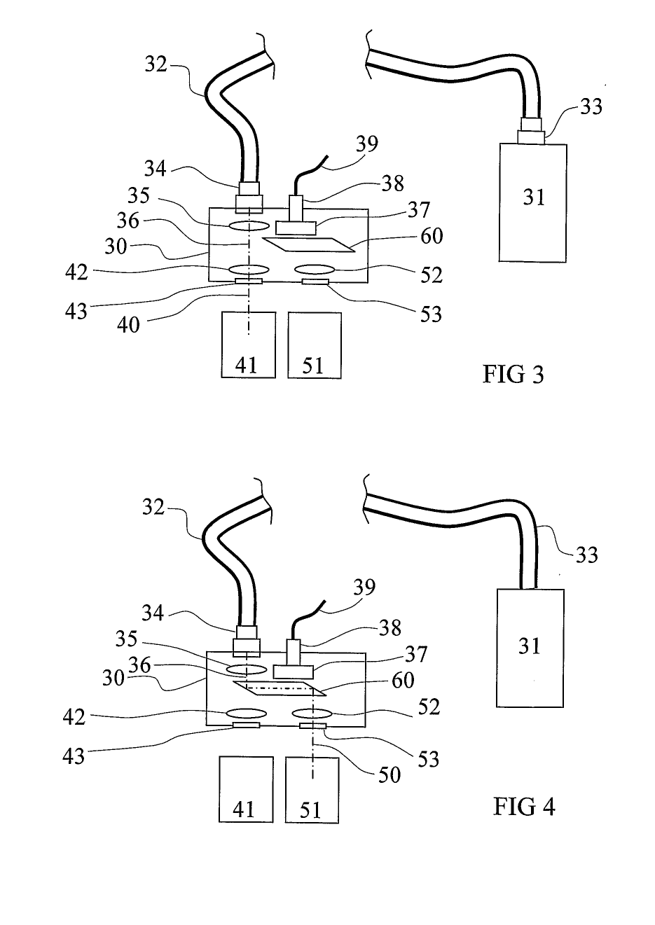

Another embodiment of the invention is shown in FIG. 3 with details of the switching mechanism. Referring to FIG. 3 there is shown a switching mechanism 30 that switches pumping radiation between two optical paths.

Output from a diode laser pump source 31 is delivered to the switching mechanism 30 by optical fibre 32. The laser pump source 31 is suitably a fibre coupled laser diode array available from Coherent Inc. The laser pump source could also be a solid state laser such as a Nd:YAG or any other suitable laser pump.

The output from the laser pump source 31 is conveniently coupled to an optical fibre 32. Although the laser pump source 31 could be directly coupled to the switching mechanism 30, as shown in FIG. 1, there is particular advantage in versatility if an optical fibre connection is employed. A conventional fibre optic coupler 33 is used to couple the output of the laser pump source 31 into the optical fibre 32. A similar coupler 34 is used to couple the optical fibre 32 into the switching mechanism 30.

The switching mechanism 30 switches the output from the optical fibre 32 between different optical paths 40, 50. The first optical path 40 (FIG. 3) directs the output of the optical fibre 32 to a first laser cavity 41 and the second optical path 50 (see FIG. 4) directs the output of the optical fibre 32 to a second laser cavity 51.

The switching mechanism 30 includes a number of optical elements including a collimating lens 35 that collimates the output from the optical fibre 32. The primary switching element 60 is a rhomboid prism in the preferred embodiment which has appropriate dimensions and angled surfaces to allow the laser beam 36 to be laterally translated. The switching element 60 is movable between a first position (shown in FIG. 3) and a second position (shown in FIG. 4). In the first position the switching element 60 allows the collimated output 36 to pass directly to an output lens 42 and through a window 43 along optical path 40 into the laser cavity 41. In the second position the switching element 60 laterally translates the collimated output 36 to pass through an output lens 52 and through window 53 along optical path 50, into the laser cavity 51.

The switching element 60 is moved between the first and second position by a linear translation stage 37 which is suitable for precise positioning of optical elements. The linear translation stage is driven by a motor 38 which is suitable for moving the switching element 60 a fixed and repeatable distance into, or out of, the beam path 36 in response to control signals which are delivered to the motor via cable 39. A linear translation stage and motor is a low cost and effective means for moving the switching element between positions. Other means may also be suitable but are likely to be less economic. It will be appreciated that the assembly consisting of the switching element 60, translation stage 37, motor 38, and control cable 39 could be repeated to allow the addition of further output ports.

The switching element 60 is shown in the preferred embodiment as being a rhomboid prism but it will be appreciated that the invention is not limited to this particular arrangement. A pair of mirrors will achieve the same beam diversion providing a sufficiently stable mount is devised. The inventors have found that the rhomboid prism has particular advantage because it is less sensitive to misalignment than other optical elements.

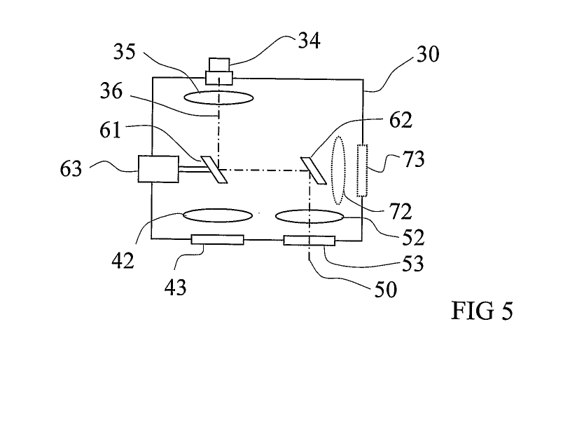

An enlarged view of an alternate embodiment of a switching mechanism 30 is shown in FIG. 5. In this case the switching element is a movable mirror 61 that acts with fixed mirror 62 to deflect the collimated output 36 to second optical path 50. The movable mirror 61 is moved by linear actuator 63 under control of a controller as described above. The arrangement shown in FIG. 5 directs the collimated output 36 along substantially parallel paths through windows 43 or 53. It will be appreciated that fixed mirror 62 could be omitted and a path through lens 72 and window 73 established which would be substantially orthogonal to path 50.

If mirror 62 is also movable it will be appreciated by persons skilled in the art that mirrors 61 and 62 can be positioned so as to direct collimated output 36 along any of three paths to windows 43, 53 or 73. In this manner a single laser diode pump source can be used for three different laser cavities.

The diode pumped laser system provides an economic advantage compared to known systems that use a single laser pump source for each laser cavity. The precision switching mechanism allows a significant cost reduction by allowing a reduction in the number of laser pump sources that are required in multi-output laser systems.

Throughout the specification the aim has been to describe the invention without limiting the invention to any particular combination of alternate features.

1. A diode laser pumped laser system comprising:
a diode laser pump source;
two or more resonant laser cavities; and
a switching mechanism having:
at least one input port receiving optical radiation from the diode laser pump source;
two or more output ports each output port directing the optical radiation to one of the two or more resonant laser cavities; and
at least one switching element directing the optical radiation from the at least one input port to a selected one of the two or more output ports.

2. The laser system of claim 1 wherein the switching element comprises one or more optical elements movable between a first position and at least a second position.

3. The laser system of claim 1 wherein the switching element is movable to direct the optical radiation along a selected optical path from the at least one input port to one of the two or more output ports.

4. The laser system of claim 1 wherein the switching element is controlled by an actuator associated with the switching element, the actuator moving the switching element between a first position and at least a second position in response to electrical control signals.

5. The laser system of claim 1 wherein the switching element is a beam shifting prism.

6. The laser system of claim 1 wherein the switching element is a rhomboid prism.

7. The laser system of claim 1 wherein the switching element is at least one mirror.

8. The laser system of claim 4 wherein the actuator is a linear translation stage.

9. The laser system of claim 1 further comprising an optical fibre that delivers the optical radiation from the diode laser pump source to the at least one input port.

10. A switching mechanism for a diode laser pumped laser system comprising:
a housing having two or more optical paths therethrough;
at least one input port receiving optical radiation directed along a common part of the two or more optical paths;
two or more output ports, there being an output port for each optical path;
at least one switching element in the housing directing the optical radiation from the at least one input port to a selected one of the two or more output ports; and
an actuator associated with the switching element, the actuator moving the switching element between the first position and at least the second position.

11. The switching mechanism of claim 10 wherein the switching element comprises one or more optical elements movable between a first position and at least a second position.

12. The switching mechanism of claim 10 wherein the switching element is movable to direct the optical radiation along a selected one of the two or more optical paths from the at least one input port to one of the two or more output ports.

13. The switching mechanism of claim 10 wherein the switching element is selected from one of: a beam shifting prism; one or mirrors; or a rhomboid prism.

14. The switching mechanism of claim 10 wherein the actuator is a linear translation stage.

15. A switching mechanism for a diode laser pumped laser system comprising:
a housing having two or more optical paths therethrough;
at least one input port receiving optical radiation directed along a common part of the two or more optical paths;
two or more output ports, there being an output port for each optical path;
at least one switching element in the housing, the switching element being movable between a first position and at least a second position to direct the optical radiation along a selected one of the two or more optical paths from the at least one input port to one of the two or more output ports; and
an actuator associated with the switching element, the actuator moving the switching element between the first position and at least the second position.
